(19) United States
(12) Patent Application Publication
(10) Pub. No.: US 2025/0005200 A1
(43) Pub. Date: Jan. 2, 2025

(54) QUANTIZATION AND CRYPTOGRAPHIC PROTOCOL BASED MACHINE LEARNING MODELS FOR CONFIDENTIAL DATA ANALYSIS AND INFERENCE

(71) Applicant: The Regents of the University of California, Oakland, CA (US)

(72) Inventors: Mojan Javaheripi, San Diego, CA (US); Mohammad Samragh Razlighi, San Diego, CA (US); Siam Umar Hussain, San Diego, CA (US); Farinaz Koushanfar, San Diego, CA (US)

(21) Appl. No.: 18/708,339

(22) PCT Filed: Nov. 8, 2022
(86) PCT No.: PCT/US2022/079453

§ 371 Date: May 8, 2024

Related U.S. Application Data
(60) Provisional application No. 63/277,077, filed on Nov. 8, 2021.

(51) Int. Cl. G06F 21/62; H04L 9/08

(52) U.S. Cl. CPC G06F 21/6254; H04L 9/085

(57) ABSTRACT

In some embodiments, there is provided a system, which comprises a processor, and at least one non-transitory computer readable media storing instructions. The stored instructions, when executed by the processor, cause the processor to perform operations comprising initiating a cryptographic protocol between a first computing environment and a second computing environment, the initiating including: securing, in association with the second computing environment, content associated with data of a user associated with the first computing environment, and securing, in association with the first computing environment, a parameter associated with a trained machine learning model, implementing the trained machine learning model on the data that is secured, the machine learning model operating on the first computing environment and the second computing environment, determining an output associated with the data that is secured, responsive to the implementing of the trained machine learning model, and providing the output to the first computing environment.

### CROSS-REFERENCE TO RELATED APPLICATIONS

This application is a national stage entry of Patent Cooperation Treaty Application No. PCT/US2022/079453 filed Nov. 8, 2022, entitled “QUANTIZATION AND CRYPTOGRAPHIC PROTOCOL BASED MACHINE LEARNING MODELS FOR CONFIDENTIAL DATA ANALYSIS AND INFERENCE,” which claims priority under 35 U.S.C. § 119(e) to, U.S. Provisional Application No. 63/277,077 filed Nov. 8, 2021, titled “CO-DESIGN OF CRYPTOGRAPHIC PROTOCOLS AND MACHINE LEARNING FOR SECURE DEEP NEURAL NETWORK EXECUTION”. The disclosures of which are incorporated herein by reference in their entirety.

### TECHNICAL FIELD

This application relates generally to the training and implementation of machine learning models that enable secure data analysis and inference.

### BACKGROUND

Various cloud based machine learning models with deep neural networks are utilized to analyze data and infer information from the analyzed data using the deep neural networks. Such machine learning models are operational in multiparty communication systems that may include, for example, a client computer and a server. The client computer may transmit locally stored data to the server, which in turn, may apply or implement one or more trained deep neural networks on the data for the purpose of facilitating inference of or determination of additional information specific to the data. For example, the client computer may be a smartphone of a patient that is utilized by the patient to transmit sensitive medical data (e.g., patient symptoms) to the server, which may then apply one or more deep neural networks, as part of one or more machine learning models, on the received medical data for the purpose of inferring or determining a diagnosis. However, the transmission of patient data and the application of the deep neural networks on the data results in the revelation of confidential patient data and exposure of proprietary information associated with the machine learning model. As such, the privacy of the client and that of the server is compromised.

### SUMMARY

In some embodiments, a method that implements quantization and cryptographic protocol based machine learning models for facilitating confidential data analysis and inference is provided. The method includes initiating a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model, implementing the trained machine learning model on the data that is secured, the trained machine learning model operating on the first computing environment and the second computing environment, determining an output associated with the data that is secured, responsive to the implementing of the trained machine learning model, and providing the output to the first computing environment.

In some variations, one or more of the features disclosed herein including the following features can optionally be included in any feasible combination. The securing of the at least one parameter associated with the trained machine learning model includes masking the at least one parameter in association with the first computing environment or encrypting the at least one parameter in association with the first computing environment. Further, the initiating of the cryptographic protocol includes performing linear operations and non-linear operations on the data, wherein the linear operations are based on arithmetic sharing protocol and the non-linear operations are based on garbled circuit protocol. Further, the linear operations includes a standard matrix multiplication operation performed on the data and a factored matrix multiplication operation performed on the data and the non-linear operations includes a max pooling operation and implementation of a rectified linear unit (ReLU) function.

In some variations, one or more of the features disclosed herein including the following features can optionally be included in any feasible combination. The training of the trained machine learning model includes performing quantization operations on operands during inference of a plurality of deep neural networks for generating a first set of parameter configuration, performing clustering operations on weights of the deep neural networks for generating a second set of parameter configurations, and implementing a parameter configuration action on the first set of parameter configurations and the second set of parameter configurations. The implementing of the parameter configuration action on the first set of parameter configurations and the second set of parameter configurations comprises: determining that at least one subset of the first set of parameter configurations satisfies a first threshold value and at least one subset of the second set of parameter configurations satisfies a second threshold value; and generating a score function based on the at least one subset of the first set of parameter configurations and at least one subset of the second set of parameter configurations.

In some embodiments, a system that implements quantization and cryptographic protocol based machine learning models for facilitating confidential data analysis and inference is provided. The system includes at least one processor; and at least one non-transitory computer readable media storing instructions that, when executed by at least one processor, cause the at least one processor to perform operations that comprise: initiating a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model, implementing the trained machine learning model on the data that is secured, the trained machine learning model operating on the first computing environment and the second computing environment, determining an output associated with the data that is secured, responsive to the implementing of the trained machine learning model, and providing the output to the first computing environment.

In some embodiments, a non-transitory computer readable media enabling the implementation of quantization and cryptographic protocol based machine learning models for facilitating confidential data analysis and inference is provided. The at least one non-transitory computer readable media stores instructions that, when executed by at least one processor, cause the at least one processor to perform operations that comprise initiating a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model, implementing the trained machine learning model on the data that is secured, the trained machine learning model operating on the first computing environment and the second computing environment, determining an output associated with the data that is secured, responsive to the implementing of the trained machine learning model, and providing the output to the first computing environment.

In some embodiments, another system that implements quantization and cryptographic protocol based machine learning models for facilitating confidential data analysis and inference is provided. The system comprises a protocol module configured to initiate a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model, a machine learning module configured to implement a trained machine learning model on the data that is secured, the machine learning model operating on the first computing environment and the second computing environment, a determination module configured to determine an output associated with the data that is secured, responsive to the implementing of the trained machine learning model; and output module configured to provide the output to the first computing environment.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example computing environment that implements a trained machine learning model in conjunction with a cryptographic protocol for enabling confidential data analysis and inference, in accordance with some embodiments;

FIG. 2 depicts concealment of a machine learning model parameter and of user data during simultaneous implementation of the trained machine learning model on the first and second computing environments, in accordance with some embodiments;

FIG. 3 depicts aspects of a data inference framework that enables confidential data analysis and inference, in accordance with some embodiments;

FIG. 4 depicts aspects of a cryptographic protocol component as part of the data inference framework, in accordance with some embodiments;

FIG. 5 depicts a graphical representation illustrating effects associated with the utilization of factored multiplication by the trained machine learning model for enabling confidential data analysis and inference, in accordance with some embodiments;

FIG. 6A depicts multiple setup and amortization times for a Local Area Network setting as part of the operation of the data inference network for enabling confidential data analysis and inference, in accordance with some embodiments;

FIG. 6B depicts multiple setup and amortization times for a Wide Area Network setting as part of the operation of the data inference network for enabling confidential data analysis and inference, in accordance with some embodiments;

FIG. 7 depicts a flow diagram for implementing the trained machine learning model for enabling confidential data analysis and inference, in accordance with some embodiments; and

FIG. 8 depicts a computing system that may implement the trained machine learning model in conjunction with a cryptographic protocol for enabling confidential data analysis and inference, in accordance with some embodiments.

### DETAILED DESCRIPTION

As stated above, multiparty communication systems utilize cloud based machine learning models with deep neural networks to analyze data of varying levels of complexity and determine or infer information associated with such data using the deep neural networks. Such cloud based machine learning models are utilized in several applications such as facial recognition and authentication, medical diagnosis and health monitoring, speech recognition, and so forth. However, implementation of such cloud based machine learning models results in the revelation of confidential and/or proprietary information of all parties of the multiparty system. For example, in the medical diagnosis and health monitoring example, a patient may reveal confidential and sensitive medical information to a medical company. Further, proprietary information related to the medical company's machine learning model may be revealed to or accessible via, for example, a smartphone of the patient. In particular, a patient may interact with a software application operating on the patient's smartphone (or laptop, and so forth) and input confidential medical patient data, which may be accessible by the server of the medical company. It is noted, however, that the confidential medical data may not be removed from the first computing environment, for example, the smartphone of the patient. Further, operation of the application on the patient's smartphone may enable the smartphone to access parameters (e.g., proprietary and/or confidential ML parameters) associated with one or more deep neural networks of one or more machine learning models of the medical company, e.g., while the model analyzes the patient's data while operating on the patient's smartphone. As such, current multiparty communication systems that utilize deep neural networks for data analysis and data inference compromise data privacy of multiple parties.

In some embodiments, the system may addresses and/or overcomes one or more of the above noted deficiencies. For example, the present disclosure describes a data analysis and inference framework that comprises a trained machine learning model operating in conjunction with a cryptographic protocol to enable data analysis and inference while maintaining data privacy and privacy of the machine learning trained model. In operation, for example, the data analysis and implementation framework may include a trained machine learning model that operates simultaneously on a smartphone of a patient and a server of a medical company. Further, in operation, the patient may request diagnosis and treatment from the medical company, which may involve the patient interacting with an application on his smartphone and inputting data, e.g., medical data that the patient would like to keep private, into the application. At this point, the patient's smartphone and the server of the medical company may concurrently initiate a cryptographic protocol, prior to communicating or sharing any data. For example, after the patient inputs the medical data via his smartphone application, the cryptographic protocol may secure the medical data (e.g., encrypt or mask the content of the data) and communicate the secure data to the server.

The smartphone of the patient and the server may then jointly implement the machine learning trained model on the securely shared medical data and generate an output, e.g., a diagnosis of an illness from which the patient may be suffering. It is noted the medical data that is shared from the patient's phone would not be accessible via or visible to the server. Further, it is noted that, in embodiments, the output that is generated by the joint implementation may also not be visible or accessible via the server. In embodiments, the generated output (e.g., the diagnosis) may be encrypted or masked and the masked output accessible to the patient's smartphone. The patient's smartphone may then utilize the cryptographic protocol to decrypt the generated result and view the diagnosis. In this way, both the medical data (e.g., sensitive data) initially provided by the patient and the diagnosis (e.g., result) determined by the server are concealed from the server.

Further, in some embodiments, while the trained machine learning model operates on the patient's smartphone, one or more parameters (e.g., weights associated with the deep neural networks of the trained machine learning model) are concealed from and not accessible via the smartphone of the user. In this way, the data analysis and inference framework maintains the data privacy of both the patient and the medical company.

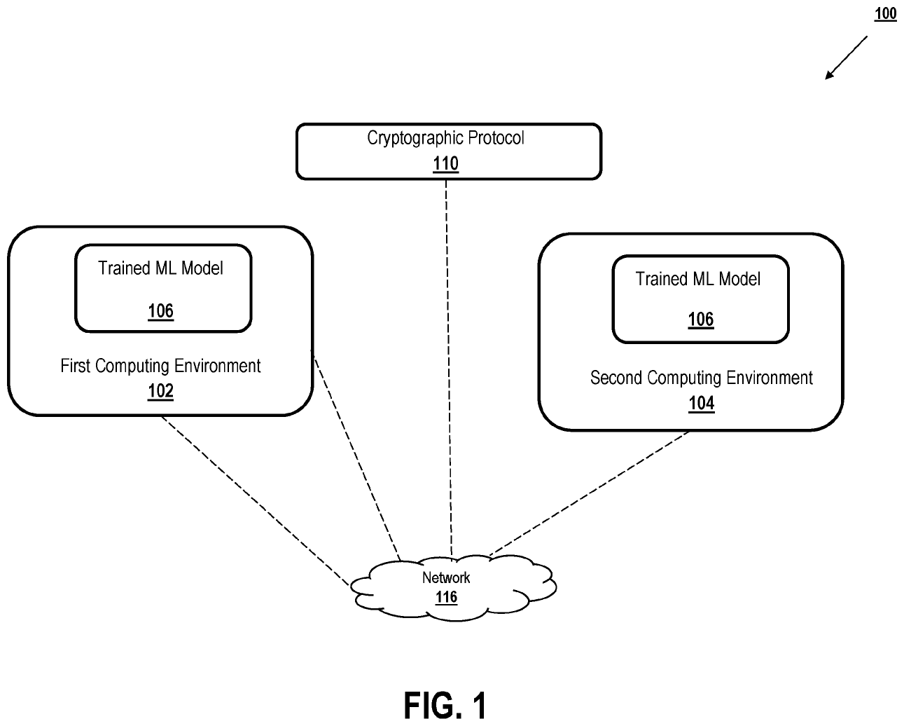

FIG. 1 depicts an example computing environment 100 that implements a trained machine learning model in conjunction with a cryptographic protocol 110 for enabling confidential data analysis and inference, according to some embodiments. As illustrated, in embodiments, the example computing environment 100 may include a first computing environment 102 that may communicate with a second computing environment 104 via a communication network 116. In embodiments the first computing environment 102 may communicate with the second computing environment 104 wirelessly or via a wired medium. It is noted that the first computing environment and the second computing environment may correspond to a system that includes at least one processor, at least one memory storing instructions for performing one or more of the various steps and actions described in the present disclosure, which may be a computer, a tablet, a smartphone, a server, and so forth.

In some embodiments, a trained machine learning model 106, which may include a plurality of deep neural networks, may operate simultaneously, on the first computing environment 102 and the second computing environment 104. For example, the trained machine learning model 106 may be associated with and proprietary to, e.g., a medical company, and operate on the second computing environment 104, which may correspond to a server of the medical company. The trained machine learning model 106 may also operate on the first computing environment 102, which may correspond to a smartphone of a user on which, e.g., a software application operates. The user may be a patient that requests a medical diagnosis from the medical company.

In some embodiments, prior to or concurrent with the implementation of the trained machine learning model 106 on the data, the first computing environment 102 and the second computing environment 104 may initiate the cryptographic protocol 110. In particular, in an example multiparty communication system that includes a patient and a medical company, a server of the medical company (corresponding to the second computing environment 104) and a smartphone phone of the patient (e.g., corresponding to the first computing environment 102) may initiate the cryptographic protocol 110. Such an initiation enables for the concealment of certain characteristics or aspects associated with the patient data stored locally in the first computing environment 102 and one or more parameters of the trained machine learning model 106.

After the initiation of the cryptographic protocol 110, an encrypted or masked version of the confidential medical data stored in the first computing environment 102 may be accessible to the second computing environment 104. For example, as stated above, the patient may interact with a software application operating on the patient's smartphone (or, e.g., a laptop, and/or other type of computer-based system or device) and input confidential medical patient data into one or more text fields, upload a file, speak into the speaker of the smartphone, and so forth. Such data may then be encrypted or masked prior to being accessible in the second computing environment 104, e.g., by the trained machine learning model 106 operating on both the first computing environment 102 and the second computing environment 104. If the medical data relates to information regarding symptoms of the patient, the patient's medical history, illness that the patient may have previous suffered, current illnesses, and so forth, such information may be considered sensitive or confidential medical information. In such instances, the initiation of the cryptographic protocol 110 may mask or encrypt the content of such medical data.

As a result, the second computing environment 104 may be prevented from accessing the content or particular subject matter of the medical data, namely because the masked or encrypted format of the received medical data will not be interpretable to, e.g., an employee of the medical company, software of the medical company, and so forth. Further, the initiation of the cryptographic protocol also enables the medical company to mask or encrypt specific parameters associated with the trained machine learning model 106, e.g., proprietary weights of the deep neural networks included in the trained machine learning model 106. As such, the first computing environment 102 may be prevented from accessing certain parameters associated with the trained machine learning model 106, namely because the masked or encrypted format of various deep neural network weights will not be visible and interpretable to the patient or any external devices, e.g., smartphone of the patient.

In some embodiments, after initiation of the cryptographic protocol 110, the trained machine learning model 106 operates to analyze the masked or encrypted data that is shared between the first computing environment 102 and the second computing environment 104, and generates a result in an encrypted form. For example, the initiating of the cryptographic protocol 110 enables the trained machine learning model 106 to access the data (e.g., inputs) from the first computing environment 102 and utilize one or more machine learning parameters of the trained machine learning model 106 from the second computing environment 104 for the purpose of determining (e.g., jointly compute) an encrypted result that is provided to the first computing environment 102. Thereafter, the initiation of the cryptographic protocol 110 may enable the first computing environment 102 to decrypt the result and present the result on, e.g., a user interface of, e.g., the patient's smartphone. In this way, the patient may be able to view and interpret the result. In some embodiments, it is noted that the decrypted result is not available for view and interpretation in the second computing environment 104.

In some embodiments, the result may be a diagnosis of a patient's illness that is accessible in the first computing environment 102, but will not be accessible in the second computing environment 104. In this way, the trained machine learning model 106 operates to analyze confidential data provided by the patient and presents a result that is accessible only to the computing environment of the patient, while simultaneously ensuring that the patient's computing environment is prevented from accessing one or more machine learning model parameters.

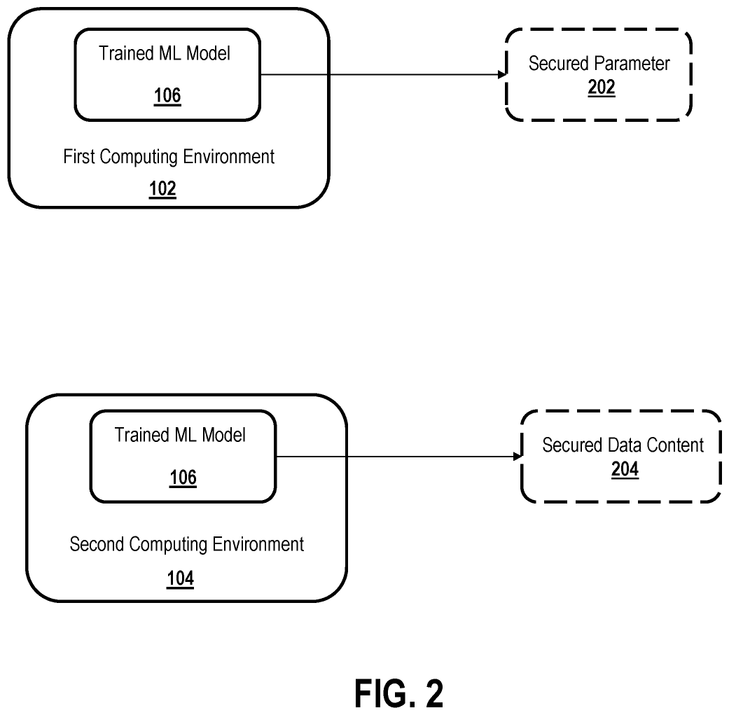

FIG. 2 depicts concealment of a machine learning model parameter and of user data during simultaneous implementation of the trained machine learning model 106 on the first computing environment 102 and the second computing environment 104, according to some embodiments. In particular, FIG. 2 depicts the operation of the trained machine learning model 106 after initiation of the cryptographic protocol 110. Returning to the patient and medical company example described above, after initiation of the cryptographic protocol 110, data available in the first computing environment 102 is securely shared and accessible to the second computing environment 104, which implements the trained machine learning model 106 on the data, enabling for or generating the inference of one or more results. The encrypted form of the results are accessible to the first computing environment 102, which decrypts the encrypted form of the results in order to access the subject matter or content of these results. The first computing environment 102 then decrypts the result such that it is visible, accessible, and interpretable to the patient. Subsequent to the initiation of the cryptographic protocol 110, a parameter of the model in the form of, e.g., deep neural network weights, is concealed from the first computing environment 102 even as the trained machine learning model 106 is implemented on the first computing environment 102 jointly with the second computing environment 104. In some embodiments, a secured parameter 202 (e.g., a concealed or encrypted parameter associated with the trained machine learning model 106) may be displayed on or be accessible to the first computing environment 102. Similarly, the content of the patient data (e.g., sensitive medical history information) is concealed from the second computing environment 104 even as the trained machine learning model is implemented on the second computing environment 104 jointly with the first computing environment 102. In some embodiments, a secured data content 204 (e.g., concealed or encrypted sensitive patient data) may be displayed on or be accessible to the second computing environment 104. It is noted that the simultaneous implementation of the trained machine learning model 106 relating to the patient and medical company is only marginally impacted by runtime. In other words, the amount of time that is takes for the second computing environment 104 to generate the results (e.g., total run time) does not significantly impact either the patient or the medical company. However, in some examples, run time may have a significant impact on at least one party of a multiparty computation system.

Another example application of the trained machine learning model 106 relates to speech recognition. In some embodiments, an example of the first computing environment 102 may correspond to a smartphone of a user and an example of the second computing environment 104 may correspond to a server associated with a search engine. The user, using his smartphone, may input a sensitive or confidential inquiry in the form of a voice command, into a software application that is accessible via and operates on the smartphone. The user may be positioned at a particular location, which he may want to keep confidential for various reasons. Further, the user may want to get directions from his current location to a different location, and would need to get this information quickly and efficiently, e.g., with limited run time.

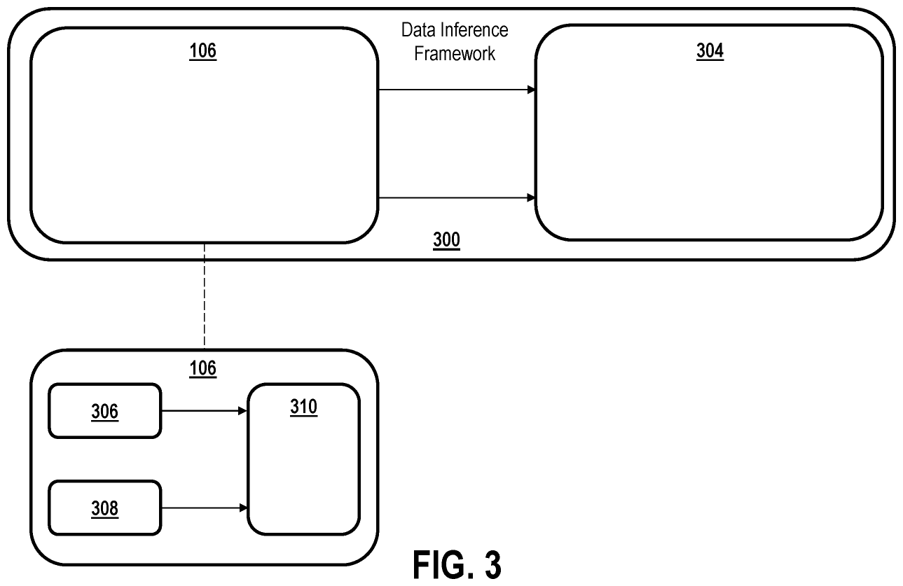

FIG. 3 depicts aspects of a data inference framework 300 that enables confidential data analysis and inference as described in the present disclosure, according to some embodiments.

In particular, the data inference framework 300 includes the trained machine learning model 106 and the cryptographic protocol component 304 as described in the present disclosure, operating independently and in conjunction. In some embodiments, the training of the trained machine learning model 106 involves performing at least a quantization of all operands involved in the inference of a plurality of deep neural networks. It is noted that operands refer to quantities or values upon which one or more operations are performed or algorithms are implemented, for example, all inputs, outputs, weights of linear layers, outputs of non-linear layers, and so forth. It is noted that deep neural networks comprise two classes or groups of layers—linear layers and non-linear layers. Examples of linear layers include convolution layers, fully connected layers, average-pooling layers, and batch normalization. Examples of non-linear layers include max pooling layers. Further, non-linear layers are associated with the use of a rectified linear unit (ReLU) function.

As stated, a part of the training of the trained machine learning model 106 involves quantization 306. In embodiments, training data utilized for training the model described in the present disclosure may in 32-bit floating-point format (FP32), which when analyzed, results in high computational costs. Further, the 32-bit floating-point format is unsuitable for implementation of the cryptographic protocol 110. As such, one or more quantization operations are performed on operands during inference of a plurality of deep neural networks for generating a first set of parameters configurations, which result in representation of the training data and the weights of the deep neural network with fewer number of bits, namely all inputs, outputs, and weights of the linear layer and input and outputs of the non-linear layers. The representation of the training data and the weights of the deep neural network with fewer number of bit involves mapping of a parameter x_{f} to its INT-b representation x_{q} using the following equation:

$${x}_{q} = round ( s \cdot {x}_{f} ) , s = \frac{{2}^{b} - 1}{2 \times max ( \vert {x}_{f} \vert )} \qquad ( 1 )$$

In the above equation, the term “s” is the scaling factor and max(|x_{f}|) denotes the maximum range that parameter x_{f} can take. In a linear layer with inputs X_{f}, weight parameters W_{f}, and bias b_{f}, the output may be approximated using quantized values as:

$${Y}_{f} = {W}_{f} \cdot {X}_{f} + {b}_{f} \approx \frac{1}{{s}_{w} {s}_{x}} ( {W}_{q} \cdot {X}_{q} + \frac{{s}_{w} {s}_{x}}{{s}_{b}} {b}_{q} ) \qquad ( 2 )$$

In the above equation, the terms Sₓ, S_{w}, and S_{b} denote the denote the quantization scales for the input, layer weights, and the bias, respectively. The quantized version of Y_{f} may be calculated using the corresponding scale S_{y} as follows:

$${Y}_{q} = round ( \frac{{s}_{y}}{{s}_{w} {s}_{x}} ( {W}_{q} \cdot {X}_{q} + \frac{{s}_{w} {s}_{x}}{{s}_{b}} {b}_{q} ) ) \qquad ( 3 )$$

The term Y_{q} is the quantized output of the linear layer which serves as the input of the next layer in a quantized DNN. In the data inference framework 300, the matrix-multiplication W_{q}·X_{q} as well as the addition of the bias vector are computed efficiently via the use of Arithmetic Sharing (AS). The evaluation of the equation expressed in (3) above is cost prohibitive due to the multiplication with 32-bit floating-point scale values Sₓ, S_{w}, S_{y}, S_{b}. To overcome this problem, scaling is optimized. It is noted that quantization of the input, weights, and outputs of the linear layer requires generating the corresponding bitwidths for each element which is determined by a parameter configuration optimizer component 310, illustrated in FIG. 3.

Further, as part of training of the model, a clustering algorithm may be applied to the weights of the deep neural network. For example, given a vectorized weight matrix w∈R^{N} and a given unique size V, a unique space c∈RV may be identified and the coded representation \tilde{w}∈{1, . . . , V}^{N} may be utilized to solve the following optimization equation:

$${min}_{c , \tilde{w}} {\sum }_{i = 1}^{N} {( c [ \tilde{w} [ i ] ] - w [ i ] )}^{2} \qquad ( 4 )$$

Further, a k-means clustering algorithm may be implemented to find a solution to the optimization equation corresponding to equation (4). The implementation of the solution may include starting with a random set for c and mapping \tilde{w}[i] to the index of the value in the unique space that is closest to w[i], described by the following:

$$\tilde{w} [ i ] = {arg min}_{j ∈ \{ 1 , ... , V \}} \vert w [ i ] - c [ j ] \vert , ∀ i ∈ \{ 1 , … , N \} \qquad ( 5 )$$

Further, the elements of the unique space are updated as follows:

$$c [ j ] = average ( \{ w [ i ] \vert \tilde{w} [ i ] = j \} ) , ∀ j ∈ \{ 1 , … , V \} \qquad ( 6 )$$

In embodiments, steps associated with equations (5) and (6) are repeated in order to compute a unique space and the coded representations. Further, for each deep neural network layer, a k-means algorithm may be implemented on the weights of the deep neural network layer with the use of different V values. Further, unique space and coded values may also be pre-computed. The pre-computed unique space and coded values may be utilized to cluster the weights of the deep neural network layers.

It is noted that parameter configurations that are derived based on the quantization operation and the clustering operation, i.e., quantization bitwidths for all operands and per-layer V values for clustering, may be input into the parameter configuration optimizer component 310. In embodiments, upon receiving training data upon which the quantization operations are performed (e.g., quantization bits) and weight clusters that are determined upon the implementation of the clustering algorithm, as described above, the parameter configuration optimizer component 310 searches through the received quantization bits and deep neural network weight clusters to identify at least a subset of the quantization bits (e.g., first set of outputs) that satisfy a first threshold value and at least a subset of the deep neural network weight clusters (e.g., a second set of outputs) that satisfy a second threshold value. The clustering operations may be implemented on the weights that comprise a plurality of deep neural networks to generate a second set of parameter configurations. Thereafter, a parameter configuration action may be implemented on the first set of configurations and the second set of configurations. Further, the parameter configuration optimizer component 310 determines or generates a score function using the subset of the quantization bits and the subset of the deep neural network weight clusters. The score function is defined according to the following equation:

$$𝒮 ( p ) = \frac{{𝒞}_{max} - 𝒞 ( p )}{ξ ( 𝒜 ( p ) )} , \qquad ( 7 )$$

In the above equation, Cₘₐₓ corresponds to an execution cost of a reference deep neural network prior to optimization. Further, the numerator of the score function enables minimization of ciphertext execution costs, defined by the term C(p), and the denominator provides a strict lower bound threshold for accuracy using exponential penalty methods described by the following equation:

$$ξ ( 𝒜 ( p ) ) = \{ \begin{matrix}{𝒜}_{max} - 𝒜 ( p ) & 𝒜 ( p ) > {𝒜}_{min} \\ {𝒜}_{max} - 𝒜 ( p ) + {e}^{𝒜 ( p ) - {𝒜}_{min}} & otherwise\end{matrix} \qquad ( 8 )$$

In the above equation, the variable Aₘₐₓ corresponds to the accuracy of a reference point deep neural network. In short, the score equation defined in equation (7) enables for the trained machine learning model 106 to operate with the cryptographic protocol 110 to reduce computational costs associated performing inference on encrypted values, while simultaneously maintaining data privacy and accuracy.

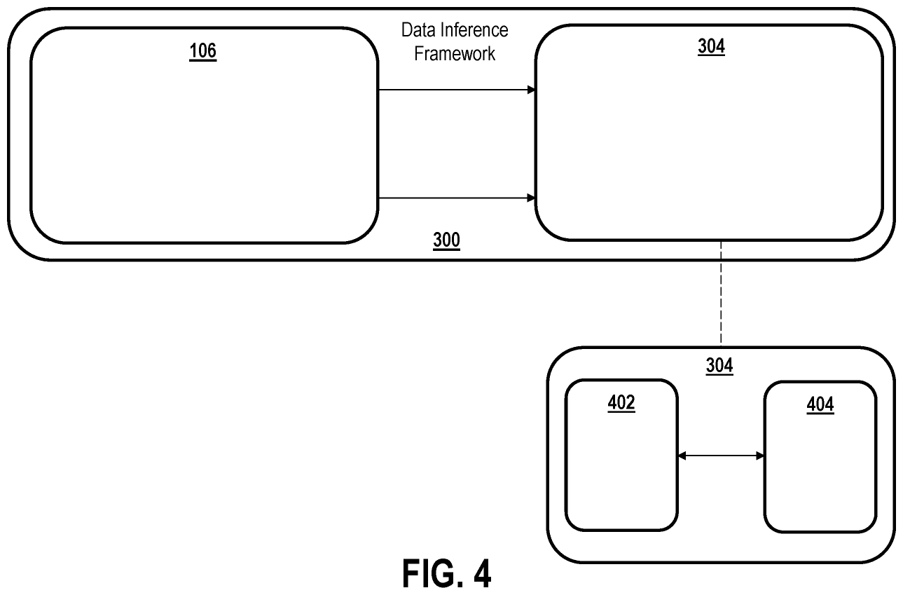

FIG. 4 depicts aspects of a cryptographic protocol component 304 as part of the data inference framework 300 illustrated in FIGS. 3 and 4. In particular, the cryptographic protocol component 304 includes linear layers 402 and non-linear layers 404. It is noted that the linear operations are based on arithmetic sharing protocol and the non-linear operations are based on garbled circuit protocol. The linear layers include the performing of a standard matrix multiplication operation and a factored matrix multiplication operation on the data. Further, the non-linear layers include a max pooling layer and the use of a rectified linear unit (ReLU) function. The max pooling layer is associated with an operation that has a window size of k×k, and further associated with a k²−1 comparison and multiplexing operations, each of which incurs a communication cost of 2·K·binp bits. As such, the max pooling operation may be performed prior to the ReLU operation for the purpose of shrinking the size of the activation tensor by a factor of K², which in turn reduces the cost associated with ReLU. It is noted that the implementation of various operations associated with the linear and non-linear layers included in the cryptographic protocol component 304 enables for the concealing and secure communication of private data, e.g., from the first computing environment 102 to the second computing environment 104, in addition to ensuring that various parameters of the trained machine learning model 106, e.g., weights of the deep neural networks, are concealed from the first computing environment 102.

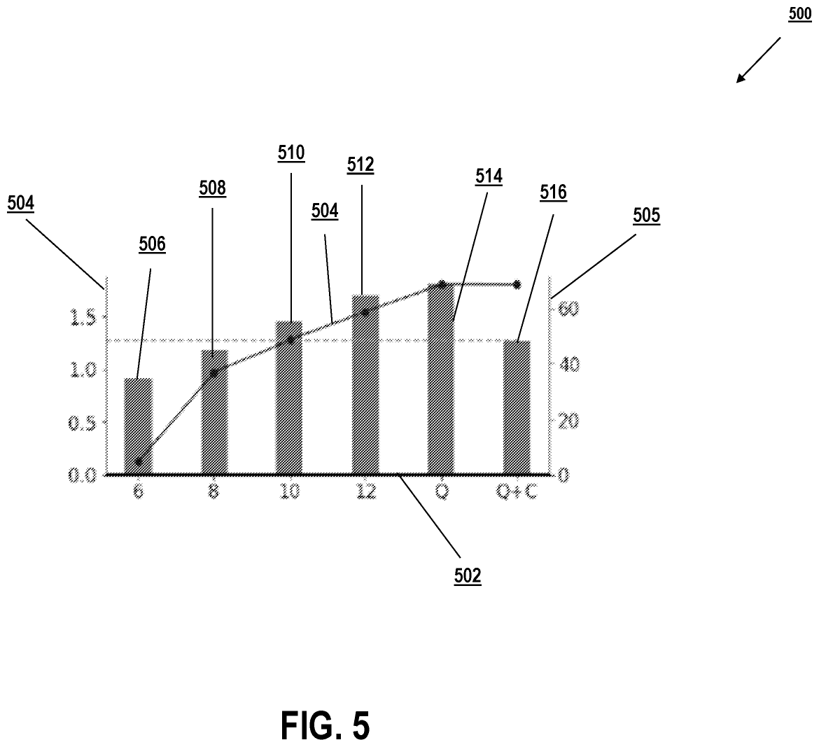

FIG. 5 depicts a graphical representation 500 illustrating effects associated with the utilization of factored multiplication by the trained machine learning model 106 for enabling confidential data analysis and inference, in accordance with some embodiments. In particular, FIG. 5 represents the accuracy of inference and the cost of communication associated with linear operations performed by linear layers 402, illustrated in FIG. 4 and described above.

In FIG. 5, the aspects of communication cost and inference accuracy are represented as a function of a number of unique elements in each layer's weight matrices, which are represented by the variable “V” on the x-axis 502. Further, the y-axis 504 of the graphical representation 500 corresponds communication of data, which may be represented in, e.g., Gigabytes (GB). Further section 505 represents accuracy values that range from 0% to approximately 60%, and the label Q represents a baseline quantized DNN of the trained machine learning model 106 as described in the present disclosure that is based on heterogeneous quantization bitwidths of, e.g., 6, 8, 10, 12, and 16, which may be determined by the parameter configuration optimizer component 310. Each of the values 506, 508, 510, and 512 represent homogeneous “V” (e.g., representative of unique elements in each layer's weight matrices), which correspond to the number 6, 8, 10, and 12, respectively, are utilized to cluster all layer weights. Further, the variable of “Q+C”, which corresponds to the value 506 represents a heterogeneous value of “V” (e.g., representative of unique elements in each layer's weight matrices) that is determined by the parameter configuration optimizer component 310 as described in the present disclosure.

It is noted that the operation of the data inference framework 300, which includes the implementation of the cryptographic protocol 110 and the trained machine learning model 106, is based at least in part on factored matrix multiplication. A description of the use of factored matrix multiplication is instructive. At the outset, a one-hot encoded representation of a vector may be defined as w∈R^{N} and its coded representation \tilde{w}∈[V]^{N} with respect to its unique space c={c₁, . . . , c_{V}}, the one-hot encoded representation of \tilde{w} is a matrix \tilde{w}∈{0, 1}^{V×N} such that \tilde{w} [v, n]=1 if \tilde{w} [n]=v and 0 otherwise (∀v∈[V], n∈[N]). It is noted that the following notations and expressions may be utilized to explain the use of the factored matrix-multiplication (i.e., secure factored matrix-multiplication) expressions:

$$The collection of unique spaces for all rows of \text{?} W \text{?} : {\{ \text{?} ∈ \text{?} \}}_{m ∈ [ M ]} \qquad ( expression 1 )$$

$$The collection of one hot encodings of all rows of \text{?} W \text{?} : {\{ \text{?} \tilde{W} \text{?} ∈ {\{ 0 , 1 \}}^{V \times N} \}}_{m ∈ [ M ]}$$

$$Partial sum : {\{ \text{?} S \text{?} ∈ \text{?} \}}_{m ∈ [ M ]}$$

$$Using the above notations , the product \text{?} Z \text{?} = \text{?} W \text{?} \cdot \text{?} X \text{?} is computed as : \qquad ( expression 2 )$$

$$\text{?} S \text{?} [ v , l ] = \text{?} \tilde{W} \text{?} [ v , n ] \cdot \text{?} X \text{?} [ n , l ] \text{?} ∀ m ∈ \text{?} \qquad ( 8 )$$

$$\text{?} Z \text{?} [ m , l ] = \text{?} e \text{?} \cdot \text{?} S \text{?} ∀ m ∈ [ M ] , l ∈ [ L ] \qquad ( 9 )$$

$$\text{?} \text{indicates text missing or illegible when filed}$$

It is noted that equation 8 of expression 2 shown above represents conditional accumulation and equation 9 of expression 2 involves a dot product operation, namely a dot product of length V vectors of b-bit integers. Further, the number of integer multiplications are reduced from MNL, as part of a regular matrix-multiplication, to MVL in the factored version, which results in reduced costs. The majority of communication costs are generated due to conditional accumulation, which may be computed using a correlated oblivious transfer (“COT”) operation, as a result of which, messages involving the same selected bit are merged together, e.g., based on equations (8) and (9) above. Thus, communication costs are significantly reduced.

It is noted that the operation of the data inference framework 300 utilizes an algorithm for computing partial sums through conditional accumulation. Such an algorithm requires MVN COT_{Lb}². As such, the cost of determining partial sums may be represented by the following expression: MVN (k+Lb). Further, the dot product, as shown in equation 9 above, may be computed using the communication cost represented by the expression of MVb(k+Lb). The protocol for determining the conditional accumulation described above may involve two separate inputs, an output, and multiple oblivious transfer messages. For example, inputs in the form of a one-hot encoding of weight matrix from party A and a share of activation by party B may be represented by the following expressions:

$$\text{?} W \text{?} : {\{ \text{?} \tilde{W} \text{?} ∈ {\{ 0 , 1 \}}^{V \times N} \}}_{m ∈ [ M ]} \qquad ( expression 3 )$$

$${\{ {μ}^{′ ( l )} ∈ \text{?} \}}_{l ∈ [ L ]} \qquad ( expression 4 )$$

$${\{ {μ}^{( l )} ∈ \text{?} \}}_{l ∈ [ L ]} \qquad ( expression 5 )$$

$$\text{?} \text{indicates text missing or illegible when filed}$$

Further, in step 1, party B may set a correlation function of φ_{m, v, n}^{(l)}(l) as the following expression: {φ_{m, v, n}(μ^{(l)}[m, v, n])}_{l∈[L]}={μ^{(l)}{m, v, n}+ [symbol] X [symbol] [symbol] [n, l]}_{l∈[L]}; ∀m∈[M], v∈[V], n∈[N]. In step 2, for each m∈[M], v∈[V], n∈[N], a plurality of actions may be performed. In particular, Party A and Party B may implement or run COT² such that party B may operate as a sender with correlation function {φ_{m, v, n}^{(l)}(⋅)}_{l∈|L|} and receive {μ^{(l)}[m, v, n]}_{l∈[L]}. Further, party A may operate as a receiver with choice bits [symbol] \tilde{W} [symbol] _{A}(m)[v,n] and receive {μ′^{(l)}[m, v, n]}_{l∈|L|}={μ^{(l)}[m, v]+ [symbol] \tilde{W} [symbol] _{A}^{(m)}[v, n]· [symbol] X [symbol] _{B}[n, l]}_{l∈|L|}. It is further noted that party A may set |S↑_{A}^{(m)} [v, l]=Σ [symbol] ^{N}(μ′^{(l)}[m, v, n]) [symbol] ∀m∈[M], v∈[V], l∈[L] and party B may set |S↑_{B}^{(m)}[v, l]=Σ [symbol] ^{M}(μ [symbol] [m, v, n]);∀m∈[M], v∈[V], l∈[L].

In addition, Table 1, provided below, provides costs associated with the performance and operation of different phases of the data inference framework 300, namely the operation of different phases of linear layers of the data inference framework 300 as compared to other frameworks.

TABLE 1

| | Per-Layer Complexity | |
|---|---|---|
| Frameworks | One Time Setup | Per-inference |
| Gazelle/Delphi/CTF2 (HE) | N/A | $𝒪 ( \frac{MNL}{{N}_{slot}} ) \cdot CostMult ( q )$ |
| MiniOnn/CTF2 (OT) | N/A | [symbol] (MNb_{acc}(κ + Lb_{acc})) |
| XONN (GC) | N/A | [symbol] (MNLb²_{acc}κ) |
| Data Inference | [symbol] (MNb_{acc}κ) | [symbol] (MNLb²_{acc}) |
| Framework 300 with | | |
| Regular Matrix | | |
| Multiplication | | |
| Data Inference | [symbol] (MVb_{acc}κ) | [symbol] (MVLb_{acc}(N + b_{acc})) |
| Framework 300 with | | |
| Factored Matrix | | |
| Multiplication | | |

In Table 1 above, the expression of Nₛₗₒₜ represents the number of slots in vectored HE operations while the expression of CostMult(q) represents the cost of one scalar multiplication in Z_{q} in HE. Further, the variable of q represents cypher-text modulus, which is approximately three times larger than the plain-text modulus represented by, p≈2^{b}^{_{acc}}. Frameworks other than the data inference framework 300 of Table 1 utilize a large but fixed bitwitdth of b_{acc} for all linear layers. In contrast, the data inference framework 300 identifies smaller values of b_{acc} that vary from one layer to another, thereby significantly reducing the costs associated with execution while simultaneously preserving accuracy. Further, the factored matrix multiplication utilized by the data inference framework 300 further reduces the execution costs of linear layers when the variable “V”, as described above is less than b_{acc}. Additionally, the data inference framework 300 further reduces the cost of protocol conversion and non-linear layers as shown in Table 6 below. It is noted that K is the computational security parameter the value of which is set to, for example, 128.

TABLE 6

| | ${input}_{dim} {\to }^{operation} {output}_{dim}$ | Ciphertext Cost | Parameters |
|---|---|---|---|
| Mat-Mult | ${X}_{N \times L} {\to }^{{W}_{M \times N}} {Y}_{M \times L}$ | $\frac{regular {MNLb}_{acc}^{2}}{factored {MVLb}_{acc} ( N + {b}_{acc} + 1 )}$ | b_{acc}: accumulator bitwidth |
| | | | V: unique size of W |
| MaxPool | ${X}_{C \times {D}_{1} \times {D}_{2}} {\to }^{k \times k} {Y}_{C \times {D}_{2} \times {D}_{2}}$ | 4κCD₂D₂(k² − 1)bᵢₙₚ | bᵢₙₚ: next layer input bitwidth |
| | | | k: window size |
| ReLU | ${X}_{C \times {D}_{1} \times {D}_{1}} {\to }^{\text{?}} {Y}_{C \times {D}_{1} \times {D}_{1}}$ | 2κCD₁D₁bᵢₙₚ | bᵢₙₚ: next layer input bitwidth |
| AS → GC | ${X}_{C \times {D}_{1} \times {D}_{1}} {\to }^{{b}_{acc} \to {b}_{inp}} {Y}_{C \times {D}_{1} \times {D}_{1}}$ | 3κCD₁D₁b_{acc} | b_{acc}: accumulator bitwidth |
| GC → AS | ${X}_{C \times {D}_{1} \times {D}_{1}} {\to }^{{b}_{inp} \to {b}_{acc}} {Y}_{C \times {D}_{1} \times {D}_{1}}$ | 3κCD₁D₁bᵢₙₚ | bᵢₙₚ: next layer input bitwidth |
| | | | b_{acc}: accumulator |
| | | | bitwidth |

$\text{?} \text{indicates text missing or illegible when filed}$

It is noted that the operation of the data inference framework 300 enables reduced runtime as part of an amortized setting. The data inference framework 300 operates to perform executions by breaking up the execution into a one-time setup phase and a per-inference phase. The setup phase is performed only a single time per client-server pair (e.g., the first computing environment 102 and the second computing environment 104 pair), irrespective of the number inputs. In operation, if the runtime for setup phase is defined by the expression TS, runtime for the per-inference phase is TI and the client has N inputs, with the total runtime being (TS+N*TI), with the runtime per inference being represented by the expression (TS/N+TI). In other words, the inference on the first input is described by the expression (TS+TI). Thereafter, for subsequent inputs, the run time is restricted to TI only.

It is noted that the average communication costs associated with computing or determining regular and factored matrix-multiplication, e.g., as a result of the operation of the data inference framework 300, is reduced with the use of amortized setting. Amortized functions such that when a server-client pair performs a large number of inferences, e.g., by implementing the trained machine learning model 106, with various inputs, the variable of W remains constant while the variable of X changes in each inference.

In regular matrix-multiplication, as W does not change, the number of correlated oblivious transfers remain the same while a message length increases to, e.g., an expression represented by JLb, in which J represent the number of inferences. Further, the average cost per matrix-multiplication is represented by the expression MNb(κ+JLb)/J≈MNLb² for large values of J. Additionally, for factored matrix-multiplication, the mean amortized cost is represented by the expression MVNLb. Per this expression, the number of communication rounds remain constant (=2), irrespective of the number of inferences J. It is noted that the execution of the protocol is split into the following phases—setup phase, offline phase, and online phase.

Regarding the setup phase, it is noted that this phase is performed per server-client pair irrespective of the number of inferences. In this phase, for regular matrix multiplication, party A and party B may perform an operation based on the expression MNb ROT_{JLb}² as part of the expression MNb COT_{JLb}². Further, party A receives MNb κ-bit seeds γ_{q}; ∀q∈[MNb] and party B receives κ-bit seed γ_{0q} and γ_{1q}; ∀q∈[\dot{M}Nb], which may later be expanded to b-bit messages ∀j∈[J], l∈[L] with the use of cryptographically secure pseudo random number generator (CS-PRNG). Such an operation ensures that the memory requirement is independent of the number of inferences. Further the communication cost of the setup phase is MNbK, while the communication cost of the setup phase for factored matrix-multiplication is MV (N+b)K.

Regarding the offline phase and online phases, it is noted that both of these phases are performed once per inference. The offline and online phases involve computation operations being performed before and after an input, e.g., input X, is available. In the offline phase, art A and party B may compute a matrix product [symbol] Z′ [symbol] = [symbol] W [symbol] _{A}· [symbol] U [symbol] _{B}∈Z_{2b}^{N×L}, which is a random matrix that is generated by party B. It is noted that seeds obtained in the setup phase for the particular index j and for each column l∈[L] of X are locally expanded for completing the COT_{Lb}². The communication costs for this phase for each j∈[J], for regular and factored matrix-multiplications are \dot{M}N\dot{L}b² and MVNLb, respectively. Further, in the online phase, party B directly sends F= [symbol] X [symbol] _{B}− [symbol] U [symbol] _{B} to party A, who locally computes [symbol] Z [symbol] _{A}= [symbol] Z [symbol] _{A}+ [symbol] W [symbol] _{A} [symbol] F [symbol] _{A}·Bob set [symbol] Z [symbol] _{B}= [symbol] Z′ [symbol] _{B}. It is noted that the communication cost in this phase is negligible compared to that of the offline phase. Further, the amortized execution method as described above is not restricted to machine learning application, namely the trained machine learning model 106. It is suitable for and applicable to any operations or scenarios involving secure matrix multiplication in which one of the inputs remains constant while another input changes with every iteration.

It is noted that a large proportion of the computation and communication of the linear layers 402 of the data inference framework 300 involves the use of a one-time setup phase that does not impact security, which is in contrast with the other frameworks of Gazelle/Delphi/CTF2 (HE), MiniOnn/CTF2 (OT), and XONN (GC).

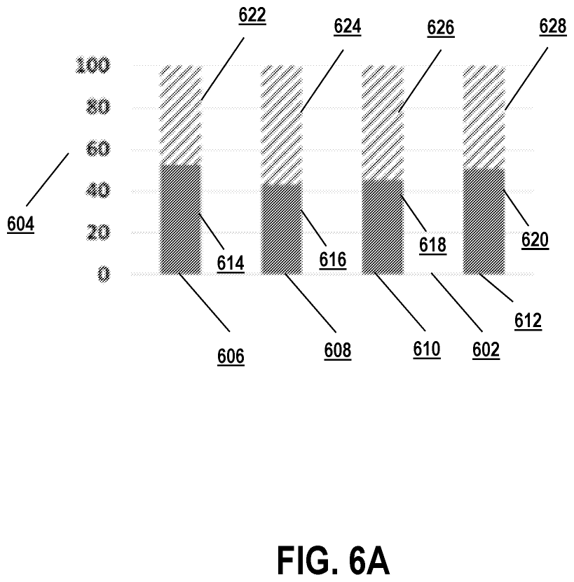

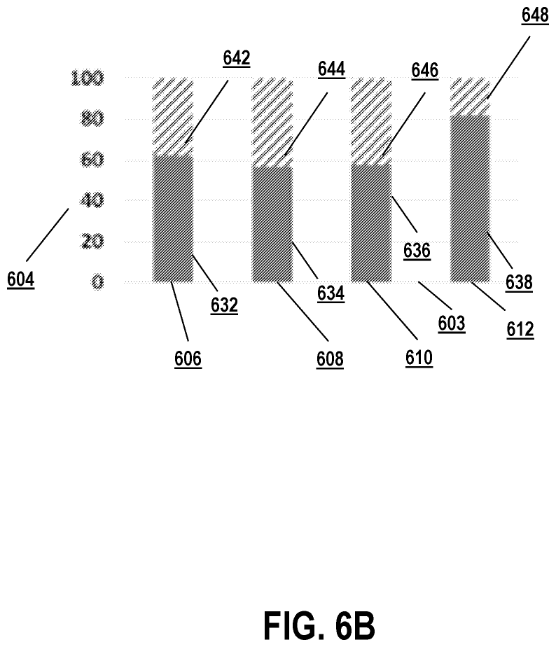

FIGS. 6A and 6B depicts multiple setup and amortization times for Local Area Network and Wide Area Network settings as part of the operation of the data inference framework 300 for enabling confidential data analysis and inference, in accordance with some embodiments. As illustrated in FIG. 6A, the x-axis 602 corresponds to Local Area Network setting and the y-axis 604 corresponds to percentage values. Further the Local Area Network setting depicts percentages values for MiniONN 606, Res32 608, Res110 610 and Res50 612. It is noted that the values 614, 616, 618 and 620 represent amortized percentages (shown in a solid texture) and the values 622, 624, 626, and 628 represent setup percentages (shown in a shaded texture). Further, as illustrated in FIG. 6B, the x-axis 603 corresponds to Wide Area Network setting and the y-axis 604 corresponds to percentage values. Further the Wide Area Network setting depicts percentages values for MiniONN 606, Res32 608, Res110 610 and Res50 612. It is noted that the values 632, 634, 636 and 638 represent amortized percentages (shown in solid texture) and the values 642, 644, 646, and 648 represent setup percentages (shown in shaded texture). In short, as shown in FIGS. 6A and 6B, the process of separating the setup time from performing an inference operation, as described above, significantly reduces the runtime.

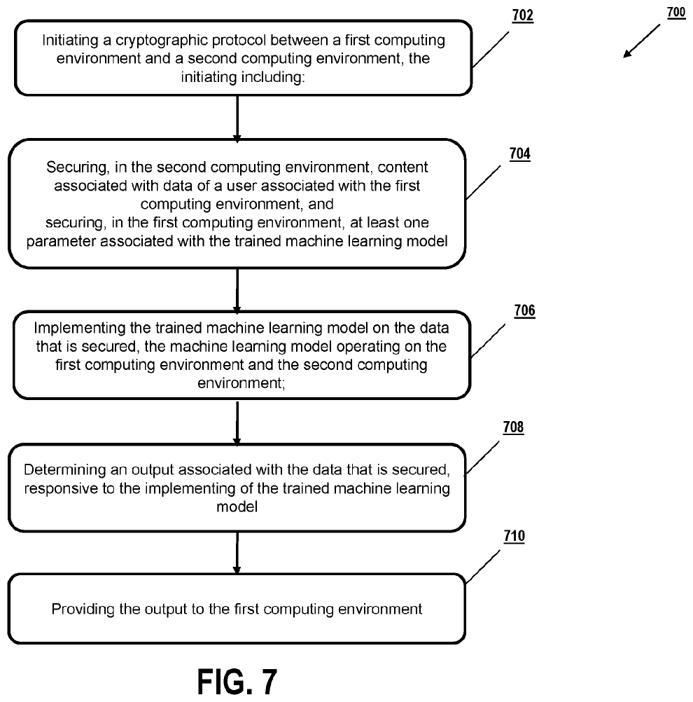

FIG. 7 depicts a flow diagram for implementing the trained machine learning model 106 for enabling confidential data analysis and inference, in accordance with some embodiments.

In particular, in block 702, a cryptographic protocol may be initiated between a first computing environment and a second computing environment. As described above, the initiation of the cryptographic protocol may enable for the concealment of data in the second computing environment and the concealment of one or more machine learning model parameters in the first computing environment.

In block 704, as part of the initiating of the cryptographic protocol, content associated with data of a user associated with the first computing environment is secured in the second computing environment and at least one parameter associated with the trained machine learning model is secured in the first computing environment. As described in the examples above, the initiation of a cryptographic protocol may enable encryption of sensitive medical data that is available locally in memory or storage of the first computing environment. The cryptographic protocol may also conceal one or more machine learning parameters, e.g., weights associated with the deep neural networks of the trained machine learning model, from the first computing environment. Further, during the joint implementation of the trained machine learning model on the first computing environment and the second computing environment, after the initiation of the cryptographic protocol, the trained machine learning model may access the encrypted sensitive medical data and, based on the cryptographic protocol, mask one or more parameters of model (which may be encrypted or masked) from the first computing environment. The entire content of the sensitive medical data may not be visible in or may be masked within the second computing environment. The cryptographic protocol may also conceal one or more machine learning parameters, e.g., weights associated with the deep neural networks of the trained machine learning model, from the first computing environment.

In block 706, a trained machine learning model may be implemented on the first computing environment and the second computing environment. As described above, the first and second computing environments may correspond to a smartphone of a user, e.g., a patient, and a server of a medical company, respectively. The implementation of the trained machine learning model corresponds to the operation of the trained machine learning model simultaneously on both the first computing environment and the second computing environment. It is further noted that, any communication or sharing of data between the first computing environment and the second computing environment occurs after or concurrently with the initiation of a cryptographic protocol, which ensures masking or concealment of data and one or more machine learning parameters.

In block 708, an output associated with the data of the user that is secured is determined responsive to the implementing of the trained machine learning model. In particular, as described in the patient and medical company example above, the second computing environment may generate an output based on the sensitive medical data. An encrypted version of this output may be accessed by the first computing environment in an encrypted form, which may then be decrypted by the first computing environment.

In block 710, the output is provided to the first computing environment. This step refers to the transmission of the output determined in block 706 to the first computing environment, which may be decrypted and viewable within the first computing environment. It is noted that the result may not be accessible in or viewable within the second computing environment.

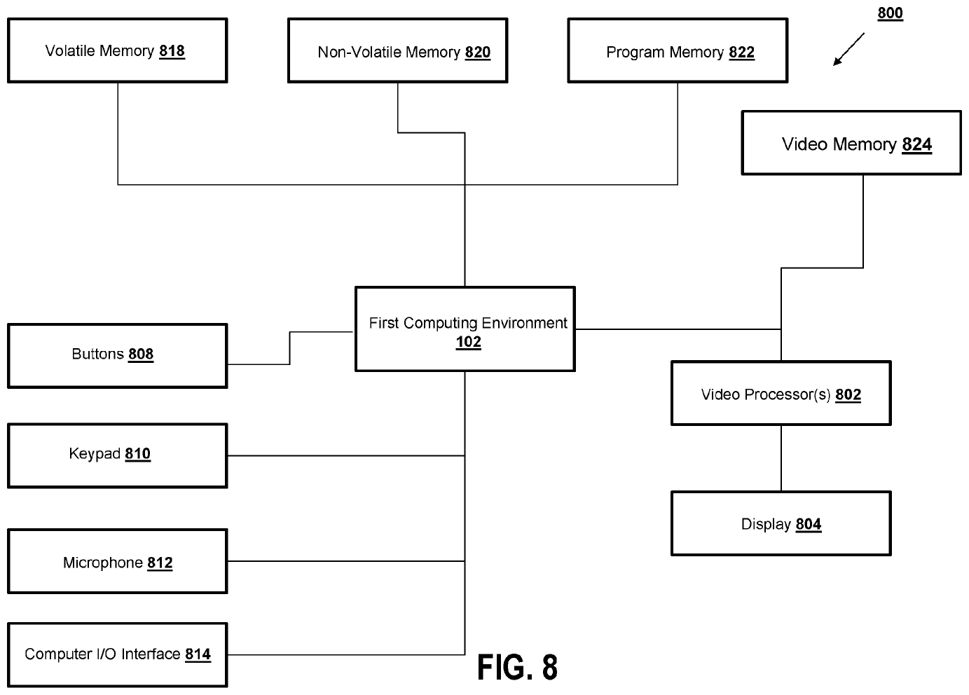

FIG. 8 depicts a computing system 800 that may implement the trained machine learning model 106 in conjunction with a cryptographic protocol for enabling confidential data analysis and inference, according to some embodiments, in accordance with some embodiments. The computing system may include a first computing environment 102 that is communicatively coupled (wired or wirelessly coupled) to a display 804, a keypad 810 (e.g., a keyboard) one or more sensors implanted in the brain of a patient, and one or more brain machine interfaces that are external to the first computing environment 102. The first computing environment 102 may also include video processors 802, buttons 808, a microphone 812, a computer input/output interface 814, memory in the form of volatile memory 818, non-volatile memory 820, and program memory 822.

The video processors 802 can provide/receive commands, status information, streaming video, still video images, and graphical overlays to/from the first computing environment 102 and may be comprised of FPGAs, DSPs, or other processing elements which provide functions such as image capture, image enhancement, graphical overlay merging, distortion correction, frame averaging, scaling, digital zooming, overlaying, merging, flipping, motion detection, and video format conversion and compression.

The first computing environment 102 can be used to manage the user interface by receiving input via buttons 808, keypad 810, and/or microphone 812, in addition to providing a host of other functions, including image, video, and audio storage and recall functions, system control, and measurement processing. The buttons 808 and/or keypad 810 also can be used for menu selection and providing user commands to the cloud server 118 (e.g., freezing or saving a still image). The microphone 812 can be used by the inspector to provide voice instructions to freeze or save a still image.

The video processors 802 can also communicate with video memory 824, which is used by the video processors 802 for frame buffering and temporary holding of data during processing. The first computing environment 102 can also communicate with program memory 822 for storage of programs executed by the first computing environment 102. In addition, the cloud server 118 can be in communication with the volatile memory 818 (e.g., RAM), and the non-volatile memory 820 (e.g., flash memory device, a hard drive, a DVD, or an EPROM memory device). The non-volatile memory 820 is the primary storage for streaming video and still images.

The first computing environment 102 can also be in communication with a computer input/output interface 814, which provides various interfaces to peripheral devices and networks, such as USB, Firewire, Ethernet, audio I/O, and wireless transceivers. This computer input/output interface 814 can be used to save, recall, transmit, and/or receive still images, streaming video, or audio. For example, a USB “thumb drive” or CompactFlash memory card can be plugged into computer input/output interface 814. In addition, the computing system 800 can be configured to send frames of image data or streaming video data to an external computer or server. The computing system 800 can incorporate a TCP/IP communication protocol suite and can be incorporated in a wide area network including a plurality of local and remote computers, each of the computers also incorporating a TCP/IP communication protocol suite.

It will be understood that, while certain components have been shown as a single component (e.g., the first computing environment 102) in FIG. 1, multiple separate components can be used to perform the functions of first computing environment 102. It is further noted that the components communicatively coupled to and associated with the first computing environment 102, as described in FIG. 8, are comparable to the components that are communicatively coupled to and associated with the second computing environment 104 in FIG. 1.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A method comprising: initiating a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model, implementing the trained machine learning model on the data that is secured, the trained machine learning model operating on the first computing environment and the second computing environment, determining an output associated with the data that is secured, responsive to the implementing of the trained machine learning model, and providing the output to the first computing environment.

Example 2: The method of Example 1, wherein the securing, in association with the second computing environment, of the data of the user includes encrypting the content of the data in association with the second computing environment.

Example 3: The method of Example 1 or Example 2, wherein: the securing of the data of the user includes masking the content of the data in association with the second computing environment.

Example 4: The method of any of Examples 1-3, wherein: the securing of the at least one parameter associated with the trained machine learning model includes masking the at least one parameter in association with the first computing environment.

Example 5: The method of any of Examples 1-4, wherein the securing of the at least one parameter associated with the trained machine learning model includes encrypting the at least one parameter in association with the first computing environment.

Example 6: The method of any of Examples 1-4, wherein the initiating further comprises: performing linear operations and non-linear operations on the data, wherein the linear operations are based on arithmetic sharing protocol and the non-linear operations are based on garbled circuit protocol.

Example 7: The method of any of Examples 1-6, wherein the linear operations comprise a standard matrix multiplication operation performed on the data and a factored matrix multiplication operation performed on the data.

Example 8: The method of any of Examples 1-7, wherein the non-linear operations comprise a max pooling operation and implementation of a rectified linear unit (ReLU) function.

Example 9: The method of any of Examples 1-8, wherein training of the trained machine learning model comprises: performing quantization operations on operands during inference of a plurality of deep neural networks for generating a first set of parameter configurations, performing clustering operations on weights of the deep neural networks for generating a second set of parameter configurations, and implementing a parameter configuration action on the first set of parameter configurations and the second set of parameter configurations.

Example 10: The method of any of Examples 1-9, wherein the implementing of the parameter configuration action on the first set of parameter configurations and the second set of parameter configurations comprises: determining that at least one subset of the first set of parameter configurations satisfies a first threshold value and at least one subset of the second set of parameter configurations satisfies a second threshold value; and generating a score function based on the at least one subset of the first set of parameter configurations and at least one subset of the second set of parameter configurations.

Example 11: A system comprising: at least one processor; and at least one non-transitory computer readable media storing instructions that, when executed by at least one processor, cause the at least one processor to perform operations comprising: initiating a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model, implementing the trained machine learning model on the data that is secured, the trained machine learning model operating on the first computing environment and the second computing environment, determining an output associated with the data that is secured, responsive to the implementing of the trained machine learning model, and providing the output to the first computing environment.

Example 12: The system of Example 11, wherein the performing of one of the operations of the initiating of the cryptographic protocol comprises performing linear operations on the data, wherein the linear operations are based on arithmetic sharing protocol.

Example 13: The system of Example 11 or Example 12, wherein the performing of one of the operations of the securing of the data of the user includes masking the content of the data in association with the second computing environment.

Example 14: The system of any of Examples 11-13, where the securing of the at least one parameter associated with the trained machine learning model includes masking the at least one parameter in association with the first computing environment.

Example 15: The system of any of Examples 11-14, wherein the performing of one of the operations of securing the at least one parameter associated with the trained machine learning model comprises masking the at least one parameter in the first computing environment.

Example 16: The system of any of Examples 11-15, wherein the performing of one of the operations of the initiating of the cryptographic protocol comprises performing non-linear operations on the data, the non-linear operations are based on garbled circuit protocol.

Example 17: The system of any of Examples 11-16, wherein the linear operations comprise a standard matrix multiplication operation performed on the data and a factored matrix multiplication operation performed on the data.

Example 18: The system of any of Examples 11-17, wherein the non-linear operations comprise a max pooling operation and implementation of a rectified linear unit (ReLU) function.

Example 19: A least one non-transitory computer readable media storing instructions that, when executed by at least one processor, cause the at least one processor to perform operations comprising: initiating a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model; implementing the trained machine learning model on the data that is secured, the trained machine learning model operating on the first computing environment and the second computing environment; determining an output associated with the data that is secured, responsive to the implementing of the trained machine learning model; and providing the output to the first computing environment.

Example 20: A system comprising: a protocol module configured to initiate a cryptographic protocol between a first computing environment and a second computing environment, the initiating including: securing, in association with the second computing environment, content associated with data of a user associated with the first computing environment, and securing, in association with the first computing environment, at least one parameter associated with a trained machine learning model; a machine learning module configured to implement the trained machine learning model on the data that is secured, the trained machine learning model operating on the first computing environment and the second computing environment; a determination module configured to determine an output associated with the data that is secured, responsive to the implementing of the trained machine learning model; and output module configured to provide the output the first computing environment.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A method comprising:
initiating a cryptographic protocol between a first computing environment and a second computing environment, the initiating including:
securing, in association with the second computing environment, content associated with data of a user associated with the first computing environment, and
securing, in association with the first computing environment, at least one parameter associated with a trained machine learning model;
implementing the trained machine learning model on the data that is secured, the trained machine learning model operating on the first computing environment and the second computing environment;
determining an output associated with the data that is secured, responsive to the implementing of the trained machine learning model; and
providing the output to the first computing environment.

2. The method of claim 1, wherein the securing, in association with the second computing environment, of the data of the user includes encrypting the content of the data in association with the second computing environment.

3. The method of claim 1, wherein:
the securing of the data of the user includes masking the content of the data in association with the second computing environment.

4. The method of claim 3, wherein:
the securing of the at least one parameter associated with the trained machine learning model includes masking the at least one parameter in association with the first computing environment.

5. The method of claim 1, wherein the securing of the at least one parameter associated with the trained machine learning model includes encrypting the at least one parameter in association with the first computing environment.

6. The method of claim 1, wherein the initiating further comprises:
performing linear operations and non-linear operations on the data, wherein the linear operations are based on arithmetic sharing protocol and the non-linear operations are based on garbled circuit protocol.

7. The method of claim 6, wherein the linear operations comprise a standard matrix multiplication operation performed on the data and a factored matrix multiplication operation performed on the data.

8. The method of claim 7, wherein the non-linear operations comprise a max pooling operation and implementation of a rectified linear unit (ReLU) function.

9. The method of claim 1, wherein training of the trained machine learning model comprises:
performing quantization operations on operands during inference of a plurality of deep neural networks for generating a first set of parameter configurations;
performing clustering operations on weights of the plurality of deep neural networks for generating a second set of parameter configurations; and
implementing a parameter configuration action on the first set of parameter configurations and the second set of parameter configurations.

10. The method of claim 9, wherein the implementing of the parameter configuration action on the first set of parameter configurations and the second set of parameter configurations comprises:
determining that at least one subset of the first set of parameter configurations satisfies a first threshold value and at least one subset of the second set of parameter configurations satisfies a second threshold value; and
generating a score function based on the at least one subset of the first set of parameter configurations and at least one subset of the second set of parameter configurations.

11. A system comprising:
at least one processor; and
at least one non-transitory computer readable media storing instructions that, when executed by the at least one processor, cause the at least one processor to perform operations comprising:
initiating a cryptographic protocol between a first computing environment and a second computing environment, the initiating including:
securing, in association with the second computing environment, content associated with data of a user associated with the first computing environment, and
securing, in association with the first computing environment, at least one parameter associated with a trained machine learning model;
implementing the trained machine learning model on the data that is secured, the trained machine learning model operating on the first computing environment and the second computing environment;
determining an output associated with the data that is secured, responsive to the implementing of the trained machine learning model; and
providing the output to the first computing environment.

12. The system of claim 11, wherein the performing of one of the operations of the initiating of the cryptographic protocol comprises performing linear operations on the data, wherein the linear operations are based on arithmetic sharing protocol.

13. The system of claim 11, wherein the performing of one of the operations of the securing of the data of the user includes masking the content of the data in association with the second computing environment.

14. The system of claim 11, where the securing of the at least one parameter associated with the trained machine learning model includes masking the at least one parameter in association with the first computing environment.

15. The system of claim 11, wherein the performing of one of the operations of securing the at least one parameter associated with the trained machine learning model comprises masking the at least one parameter in the first computing environment.

16. The system of claim 11, wherein the performing of one of the operations of the initiating of the cryptographic protocol comprises performing non-linear operations on the data, the non-linear operations are based on garbled circuit protocol.

17. The system of claim 16, wherein the linear operations comprise a standard matrix multiplication operation performed on the data and a factored matrix multiplication operation performed on the data.

18. The system of claim 17, wherein the non-linear operations comprise a max pooling operation and implementation of a rectified linear unit (ReLU) function.

19. At least one non-transitory computer readable media storing instructions that, when executed by at least one processor, cause the at least one processor to perform operations comprising:
initiating a cryptographic protocol between a first computing environment and a second computing environment, the initiating including:
securing, in association with the second computing environment, content associated with data of a user associated with the first computing environment, and
securing, in association with the first computing environment, at least one parameter associated with a trained machine learning model;
implementing the trained machine learning model on the data that is secured, the trained machine learning model operating on the first computing environment and the second computing environment;
determining an output associated with the data that is secured, responsive to the implementing of the trained machine learning model; and
providing the output to the first computing environment.

20. A system comprising:
a protocol module configured to initiate a cryptographic protocol between a first computing environment and a second computing environment, the initiating including:
securing, in association with the second computing environment, content associated with data of a user associated with the first computing environment, and
securing, in association with the first computing environment, at least one parameter associated with a trained machine learning model;
a machine learning module configured to implement the trained machine learning model on the data that is secured, the trained machine learning model operating on the first computing environment and the second computing environment;
a determination module configured to determine an output associated with the data that is secured, responsive to the implementing of the trained machine learning model; and
output module configured to provide the output the first computing environment.
